(19) United States
(12) Patent Application Publication
(10) Pub. No.: US 2012/0272068 A9
(43) Pub. Date: Oct. 25, 2012

(54) CONTENT DISTRIBUTION WITH RENEWABLE CONTENT PROTECTION

(76) Inventors: Aaron Marking, Portland, OR (US); Kenneth Goeller, Los Angeles, CA (US); Jeffrey Bruce Lotspiech, Henderson, NV (US)

(21) Appl. No.: 12/713,111

(22) Filed: Feb. 25, 2010

Related U.S. Application Data
(63) Continuation-in-part of application No. 10/945,623, filed on Sep. 20, 2004.
(60) Provisional application No. 61/155,489, filed on Feb. 25, 2009.
(60) Provisional application No. 61/159,054, filed on Mar. 10, 2009.

(51) Int. Cl. G06F 12/14; G06F 17/00

(52) U.S. Cl. 713/189; 700/94

(57) ABSTRACT

A method of renewing encryption applied to a content file in a playback device comprising determining a specified variant of at least one microcode function to be used in playing back the content file, determining if variants are stored in internal memory on the playback device to determine if the specified variant is included in the stored variants, retrieving the specified variant from a variant storage in a memory located in a media device in communication with the playback device, if the specified variant is not included in the stored variants, and using the specified variant to access the content file. A playback device has at least one memory having a variant storage, the variant storage including at least one variant of a microcode function, and a processor configured to execute instructions to determine at least one specified variant, access the variant storage of at least one memory to acquire the specified variant, and use the specified variant to decrypt a content file downloaded to a media device in communication with the playback device.

### RELATED APPLICATIONS

This application is a continuation of and claims priority to U.S. Provisional Patent Applications 61/155,489, filed Feb. 25, 2009, and 61/159,034, filed Mar. 10, 2009.

This application is related to and claims priority to co-pending U.S. patent application Ser. No. 10/945,623, filed Sep. 20, 2004, incorporated by reference herein.

### BACKGROUND

The packaging of media content, such as video or audio content, into digital media files has made the exchange of the content very easy and convenient for users. However, users freely exchanging content may violate the content owner's property rights. One area of ensuring that only authorized users are exchanging authorized content is to provide mechanisms to verify platforms, users and content. In one example, the hardware used to receive and playback the content is verified and the hardware may be referred to as being ‘trusted.’ However, gaps still exist in verification of trusted hardware, allowing pirates and other illegal users to receive and duplicate content files, violating copyrights and committing outright theft.

Content owners also want to restrict the copying of copyright protected content. There are many examples of technologies that make the transfer of copyright protected content very difficult. When physical media is used to store content, permanently or temporarily, for example in electronic purchase, rental and subscription movie service business models, content owners or their licensees use a variety of cryptographic binding methods. These methods typically use a unique media or device identifier or similar player attributes in a cryptographic function to protect the content from being copied or transferred such that it may be said to be bound to the device. Generally, this binding of the content is based upon a particular playback device, which is undesirable for users. Users may want to play their content on a different device than the device that received the content or they may want to transfer it among several personal devices.

As an example of the current art, Blu-ray optical movie discs are protected by a system called Advanced Access Content System (AACS). For some of the cryptographic functions needed in this system (e.g., “AES-H” and “AES-G3”), AACS has defined arbitrary constants. AACS has published the constants they chose. This has turned out to be a boon for attackers reverse-engineering players, because they merely look for the published constants and see where they are referenced to find sensitive cryptographic code, as a first step to finding secret keys.

Of course, it is possible to keep cryptographic constants as confidential information. This was practiced by 4C Entity and their system called Content Protection for Recordable Media (CPRM). However, hundreds of manufacturers and thousands of engineers need to learn the constants, so they do not stay secret for long.

It is recognized by anyone skilled in the art, that exact details of cryptographic calculations are often arbitrary and can be modified without changing the fundamental security of the operation. For example, exclusive-or operations can always be replaced by addition operations. Likewise, secret values can by transformed by constant operations without affecting their secrecy. Modifications such as these, if they remain confidential, offer a significant obstacle to attackers trying to reverse-engineer.

In the prior art, US Application Publication No. 2008/0133938, U.S. patent Ser. No. 11/981,977, filed Oct. 31, 2007, “Self-protecting digital content,” disclose an example of another way to provide renewability. Their approach operates at a much higher level in the system than firmware, and does not allow the changing of low-level cryptographic operations. It does not offer protection against reverse-engineering to find cryptographic keys. It also does not protect against dishonest employees from revealing confidential information.

One approach involves peering of content, where users transfer data amongst themselves. In order to preserve copyrights and to avoid pirating of the content, a ‘non-autonomous’ peering system may be employed. The system is ‘non-autonomous’ in that it includes mechanisms that only allow access to the content through a centralized authority, while allowing users to transfer media content between themselves.

Examples of a non-autonomous peering system can be found in U.S. Pat. No. 7,165,050, and US Patent Publication No. 20060064386, both titled, “Media on Demand Via Peering.” An example of methods of manufacturing and binding components usable in a non-autonomous peering system can be found in U.S. patent application Ser. No. 12/369,708, “Simple Non-Autonomous Environment, Watermarking And Authentication,” filed Feb. 11, 2009.

### BRIEF DESCRIPTION OF THE DRAWINGS

FIG. 1 shows an example of a content distribution system.

FIG. 2 shows an embodiment of a renewal process of a content protection scheme.

FIG. 3 shows an embodiment of using renewable functions to access secured content on a media device.

### DETAILED DESCRIPTION OF THE EMBODIMENTS

The below discussion uses several terms that may become confusing. The discussion uses the term ‘media’ and ‘media device’ to refer to a non-volatile memory device that contains ‘content.’ ‘Content’ includes any type of experiential content and includes, but is not limited to, movies, television shows, recorded performances, video files, audio files, and games. The media may include removable media, such as flash memory drives, so-called ‘thumb’ drives, memory cards, embedded flash memory, and memory sticks, but no limitation is intended, nor should any be implied by these examples.

The media device may interface with a ‘playback device,’ where a playback device is any device having a controller, also referred to as a processor or a system on a chip (SoC), a memory and the ability to interface with the media, whether as embedded media or removable media. Examples include, but are not limited to, televisions, video projectors, digital video recorders, set-top boxes, kiosks, personal computers, and mobile computing devices including smart phones, media players, netbooks and tablet computers.

While the below discussion may include examples and principles generally associated with the Simple Non-Autonomous Peering (SNAP) system set out in the patent and applications above, those examples are merely to aid in the understanding of the embodiments here and to provide examples of possible implementations of the embodiments here.

The embodiments described here allow confidential variations to constants and other cryptographic calculations to be quickly and easily changed, even on a movie-by-movie basis. The embodiments hide these details even from manufacturers, until they are actually deployed in the field. One should note that the SPDC approach discussed in the Background and the approach discussed here could be used in the same system. The components of SPDC operate at a much higher level than firmware, and the embodiments here allow changing of low-level cryptographic functions.

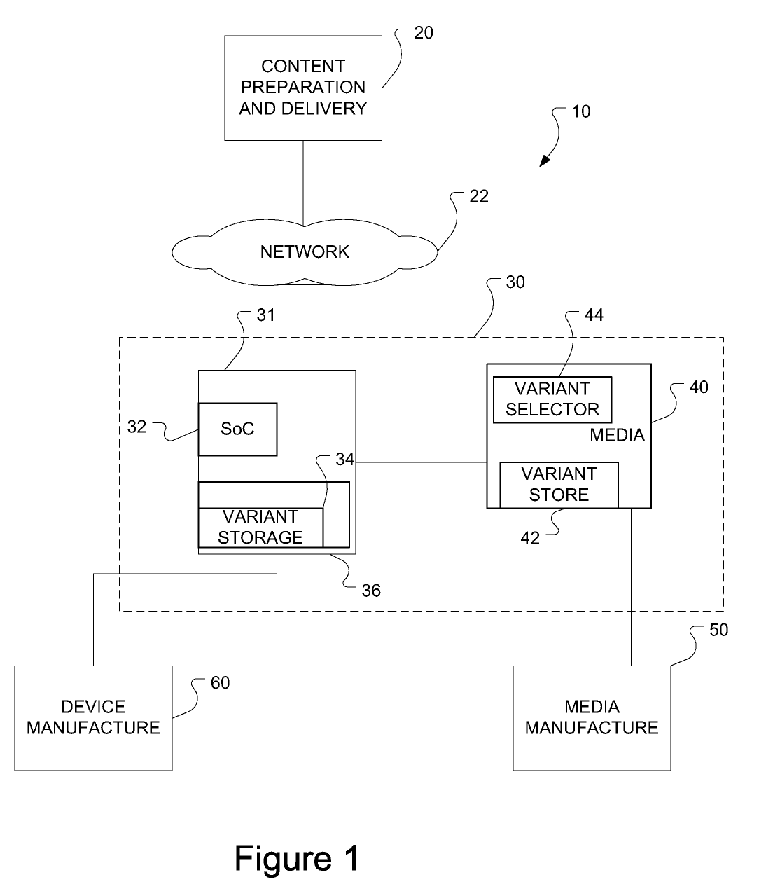

FIG. 1 shows a content distribution system 10 having a renewable content protection. An issue that arises in downloadable content in widely distributed systems lies in the ability to refresh or renew the content protection used to ensure that the content does not become compromised. By providing a renewable protection scheme, the content distribution system allows for updating the protection scheme periodically and/or when the current protection scheme becomes compromised.

In FIG. 1, the content preparation and delivery module 20 prepares content for delivery to consumer devices across the network 22. Content preparation and delivery may include SNAP-related features, such as the SNAP striping and binding scheme discussed in the patent and applications mentioned above, or any other type of encryption, coding or protection scheme intended to prevent pirating of the content. The content preparation and delivery system may also provide such services as purchase, rental and subscription of the content, licensing accounting and payouts to content providers, updating content libraries, etc.

The playback device 30, as mentioned above, may be any type of playback or content access device. The playback device, as that term is used here, includes a player 31 and the media 40, which may be removable or embedded. The player 30 has a processor or system on a chip (SoC) 32 that performs many of the processes that will be the subject of further discussion. The player 30 has variant storage 36 for storing variations of cryptographic functions, discussed in more detail later.

The player 31 also interfaces to a media device 40, which may consist of removable media such as a memory stick, SD card or thumb drive, or may be an embedded device. The media device or media 40 has a variant store 42 and variant selector 44 employed in the renewable protection scheme as will be discussed in more detail further.

In the SNAP environment example, the player 31 will generally be a certified SNAP-compliant device that has a SoC that is identified by unique keys installed by device manufacturer 60. Likewise, the media device 40 has unique keys installed by media manufacturer 50. The purpose of these keys is to allow cryptographic authentication between the player 31 and the media device 40 to form the playback device 30. Also, it allows authentication between the content preparation and delivery 20 and the media device 40.

In one embodiment, the cryptographic authentication is based on media key blocks, such are used in AACS and CPRM. However, other cryptographic protocols, such as public/private key, are within the scope of this invention.

The variant storage 36 and 42 store a predetermined number of variants. A ‘variant’ as that term is used here is a particular version of a microcode that is used to derive the necessary keys and/or functions to access the content. A ‘microcode function’ as used here refers to a set of firmware instructions, algorithms and constants used by a player to perform cryptographic and other media-related functions. Upon manufacture, the playback device 30 may have stored in it some predetermined number of these variants. These variants are stored encrypted in the player device 30 and the media device 40.

In addition, there may be several different types of variants. In the SNAP system, for example, different types of variants may exist. A first variant may be used to derive a unique code related to the media device, and a second variant may use that in conjunction with another unique identifier for the media to verify the media. A third variant may be used to derive the keys to unlock or decrypt the content that is downloaded to the media. Other types of variants may be used, or the example variants given may not be used in any particular system depending upon the protection needs of the content.

Because the predetermined number of variants may be exhausted over time, the renewable protection scheme provides for a means to renew the variants as needed. The system generally accomplishes this by transmitting new variants with the downloaded content. The media device 40 of FIG. 1 stores the downloaded content for playback by the playback device.

The media has a variant store 42 in which more variants are stored. In addition, the media persistent stores some sort of variant selector 44. This allows the SoC of the playback device to determine what variant to use in deriving the various microcode function variants. A particular example of this variant selector is discussed in detail below. The variant selector may be stored in the variant storage 42 or may be anywhere on the media.

For example, imagine a system in which variant #1 was initially deployed for all content. Either due to the lapse of some predefined period or due to a concern that variant #1 had been compromised, variant #2 becomes active. The variant selector downloaded with new content identifies variant #2. If the playback device does not have variant #2, being originally only provisioned with variant #1, the playback device can access the persistent store of the media to access variant #2.

In the SNAP-specific embodiments mentioned above, the variant selector 44 consists of a selection file. The selection file specifies the variant file to be used to access the content files and the key used to decrypt the variant file. A variant file contains the microcode function variant to be used to access the content files.

Because the selection file contains a cryptographic key, it must be delivered only after a successful cryptographic authentication between the player device 30 and media device 40. For example, in CPRM, this could be achieved by storing the selection file in the CPRM media device's Protected Area. However, other methods of delivering secret information after authentication are well known and within the scope of this invention.

Note that because variants are unique to the instruction set of the SOC 32, if there is more than one type of SOC supported by the system, each variant must come is several flavors, one for each type of SOC. If a variant is being delivered in on the media device 40 in variant storage 42, it must be delivered in all the flavors of SOC supported by the system.

It is possible that variants will be deployed on existing media in variant storage 42, and a new SOC type may be defined in the system. In that case, the variants deployed on the media devices will not contain a flavor suitable for the new SOC type. In order for a playback device 30 with a new type SOC 32 to play content on old media devices 40, such a playback device 30 must have all variants in its own variant storage 36 that were previously delivered in media device variant storage 42.

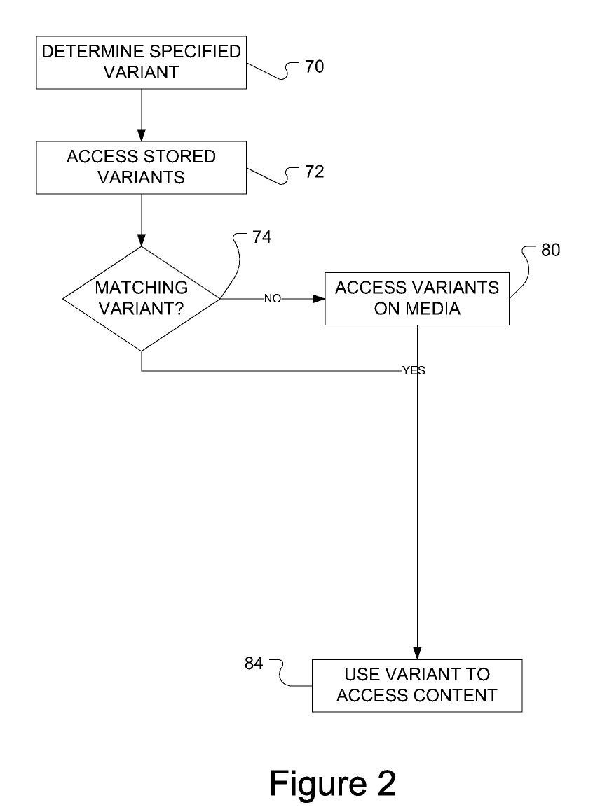

FIG. 2 shows a flowchart of an embodiment of this process. Upon download of the content, or insertion of a media device to which content had been previously downloaded such as at a kiosk, the playback device accesses the persistent store of the media to determine the specified variant at 70. Note that this process may repeat for each type of variant needed in any given protection scheme, and a selector may be provided with each content file, such as one for each movie, where a particular movie uses a different variant from other movies stored on the same media.

Once the version or number of the specified variant is determined, the stored variants on the playback device are accessed at 72. This part of the process may become optional, as the device may become ‘aware’ that the specified variant version will not exist in the stored variants and it may go straight to the media to retrieve the correct variant. Alternatively, the player may not be provisioned with any variants.

At 74, the playback device, meaning the processor or SoC on the playback device, determines whether or not the playback device has the specified variant. As mentioned previously, this portion may become optional as time progresses and the stored variants become obsolete, or if the playback device did not have any variants provisioned at manufacture. If the playback device has the matching variant, that variant is used to access the content or perform other cryptographic or media-related operations at 84. As discussed previously, this may repeat as needed to access different types of variants.

Returning to 74, if the playback device does not find a matching variant, the playback device accesses the persistent store on the media at 80. This demonstrates the renewability of this content protection scheme, where new variants and new selectors can be deployed on the media either periodically or after a suspected compromise of the deployed variants occurs. The new variant is then used to access the content at 84.

It is possible that more than the predetermined number of variants will have been deployed and after that a new platform or playback device is authorized. The new player added later would be provisioned with all variants released to date.

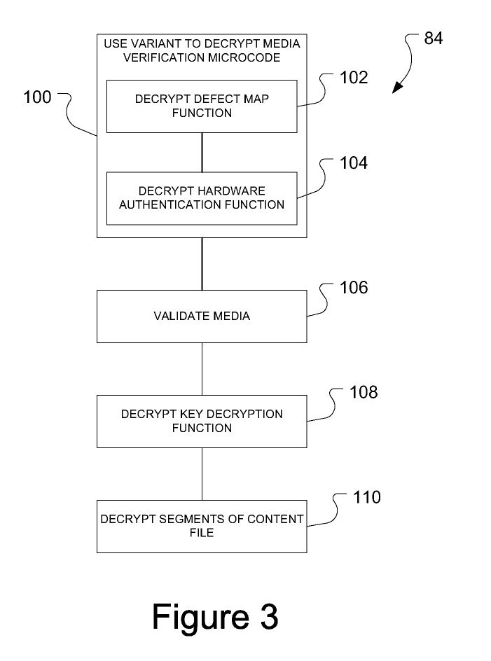

In the particular example of a SNAP system, one can see how the variant would be used to access the content, shown at 84 in FIG. 2. FIG. 3 shows an example of a SNAP-specific embodiment. At 100, the variant is used to decrypt media verification microcode. In this example, the media verification is a two-step process. A first type of variant is used to decrypt a defect map of the media. As mentioned previously, the manufacturer of the media may provide some sort of unique ID code for the media. The defect map undergoes a form of ‘obfuscation’ and then encryption that can be decrypted and decoded by the appropriate variant and compared to the actual defect map of the media to ensure that they match. This function is derived at 102. The second step in the media verification process is to use the hardware defect map and some other characteristic of the media, such as its serial number, to derive a hardware authentication code (HAC) at 104. This is then compared to the existing HAC to further ensure that the media is valid at 106.

Another type of variant provides the function that recovers the keys to decrypt the actual content. In the SNAP example, the content has been segmented, encrypted and striped in each instance of the content file. The keys provided are specific to the particular instance having the particular encryption and segments of the content stored on the media. Once the appropriate variant is used, the keys are obtained at 108 and the stripes are decrypted at 110.

However, as mentioned above, the different types and numbers of variants used, as well as the different numbers of versions of the variants depend upon the content distribution system and the protection needs of that content. No limitation is intended, nor should any be implied, to the specific examples given above.

In this manner, the content protection scheme can be renewed indefinitely for the content distribution system. This allows the system to be scalable, robust and less likely to fall prey to pirates. While the above discussion focused on renewable microcode functions, one skilled in the art will understand that it applies to other cryptographic concepts such as media key bundles (MKBs) and public/private key pairs.

Although there has been described to this point a particular embodiment for a method and apparatus for renewable security transactions in a SNAP environment, it is not intended that such specific references be considered as limitations upon the scope of this invention except in-so-far as set forth in the following claims.

What is claimed is:

1. A processor-controlled method of renewing encryption applied to a content file in a playback device having a processor configured to execute instructions such that the processor performs:
determining a specified variant of at least one microcode function to be used in playing back the content file;
determining if variants are stored in internal memory on the playback device to determine if the specified variant is included in the stored variants;
retrieving the specified variant from a variant storage in a memory located in a media device in communication with the playback device, if the specified variant is not included in the stored variants; and
using the specified variant to access the content file.

2. The method of claim 1, wherein determining the specified variant comprises accessing a selection file in which the specified variant is identified.

3. The method of claim 2, wherein accessing the selection file comprises accessing a selection file in a variant storage of the memory located in the media device.

4. The method of claim 1 wherein accessing variants stored on the playback device comprises accessing a predetermined number of variants that were loaded on the playback device upon manufacture.

5. The method of claim 1, wherein retrieving the specified variant from the variant store of the memory on the media device comprises retrieving the specified variant that was loaded into the memory upon download of the content file.

6. The method of claim 1, wherein determining if variants are stored in internal memory comprises determining that no variants are stored in internal memory.

7. The method of claim 1, further comprising repeating the determining, accessing, retrieving and using for at least one other type of variant.

8. The method of claim 1, wherein using the specified variant to access the content file comprises using the specified variant to validate the media device prior to playing back the content file.

9. The method of claim 1, wherein using the specified variant to access the content file comprises using the specified variant to decrypt segments of the content file to allow playback of the content file.

10. The method of claim 1, further comprising storing the specified variant on the playback device.

11. The method of claim 1, further comprising allowing the playback device to access and use the specified variant, but preventing the playback device from storing the specified variant.

12. A playback device, comprising:
at least one memory having a variant storage, the variant storage including at least one variant of a microcode function; and
a processor configured to execute instructions to:
determine at least one specified variant;
access the variant storage of at least one memory to acquire the specified variant; and
use the specified variant to decrypt a content file downloaded to a media device in communication with the playback device.

13. The playback device of claim 12, wherein the at least one memory comprises one of an internal memory in the playback device and a media device in communication with the processor.

14. The playback device of claim 13, wherein the internal memory includes a predetermined number of variants.

15. The playback device of claim 12, wherein the media device includes variants downloaded with the content file.

16. The playback device of claim 12, wherein the processor determines at least one specified variant by accessing a selection file in the variant storage, the variant storage located on the media device.

17. The playback device of claim 16, wherein the processor is further configured to execute instructions to acquire a key from the selection file and use that key to decrypt the variant

18. The playback device of claim 12, wherein the processor is configured to determine a variant used to validate the media device and a variant used to decrypt the content file.

19. The playback device of claim 12, wherein the playback device comprises a player and a media device.
